(19) United States
(12) Patent Application Publication
(10) Pub. No.: US 2014/0204309 A1
(43) Pub. Date: Jul. 24, 2014

(54) ELECTRONIC APPARATUS

(71) Applicant: KABUSHIKI KAISHA TOSHIBA, Tokyo (JP)

(72) Inventors: Hirofumi SAKURAI, Kumagaya-shi (JP); Hisayuki MIHARA, Honjo-shi (JP); Harumi TANABE, Hamura-shi (JP)

(21) Appl. No.: 14/015,902

(22) Filed: Aug. 30, 2013

Related U.S. Application Data
(63) Continuation of application No. PCT/JP2013/058419, filed on Mar. 22, 2013.

(30) Foreign Application Priority Data
Jan. 24, 2013 (JP) 2013-011015

(51) Int. Cl. G02F 1/1335

(52) U.S. Cl. CPC G02F 1/1336
USPC 349/61

(57) ABSTRACT

An electronic apparatus according to one embodiment includes a first board, a second board, light emitting elements and an image display. The second board is attached to the first board and thermally connected to the first board. The light emitting elements are provided on the second board and configured to emit light. The image display is configured to be illuminated by the light emitting elements and to display an image.

### CROSS REFERENCE TO RELATED APPLICATIONS

This application is a Continuation Application of PCT Application No. PCT/JP2013/058419, filed Mar. 22, 2013 and based upon and claiming the benefit of priority from Japanese Patent Application No. 2013-011015, filed Jan. 24, 2013, the entire contents of all of which are incorporated herein by reference.

### FIELD

Embodiments described herein relate generally to electronic apparatuses.

### BACKGROUND

For example, a liquid crystal display (LCD) mounted in a liquid crystal television comprises a liquid crystal panel which displays images, and a backlight which illuminates the liquid crystal panel from behind. As the backlight, a direct type comprising a plurality of light sources such as LEDs behind the liquid crystal panel is known. In the direct type of backlight, the number of light sources can be easily reduced compared with other types of backlight.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing a television according to a first embodiment.

FIG. 2 is a front view of the television according to the first embodiment.

FIG. 3 is a cross-sectional view showing a relay board, a first LED bar and a heat releasing member according to the first embodiment.

FIG. 4 is a view schematically showing a circuit formed on the relay board according to the first embodiment.

FIG. 5 is a perspective view showing a display module and a stand according to the first embodiment.

FIG. 6 is a cross-sectional view showing a relay board, a first LED bar and a heat releasing member according to a second embodiment.

### DETAILED DESCRIPTION

Various embodiments will be described hereinafter with reference to the accompanying drawings.

In general, according to one embodiment, an electronic apparatus comprises a first board, a second board, light emitting elements and an image display. The second board is attached to the first board and thermally connected to the first board. The light emitting elements are provided on the second board and configured to emit light. The image display is configured to be illuminated by the light emitting elements and to display an image.

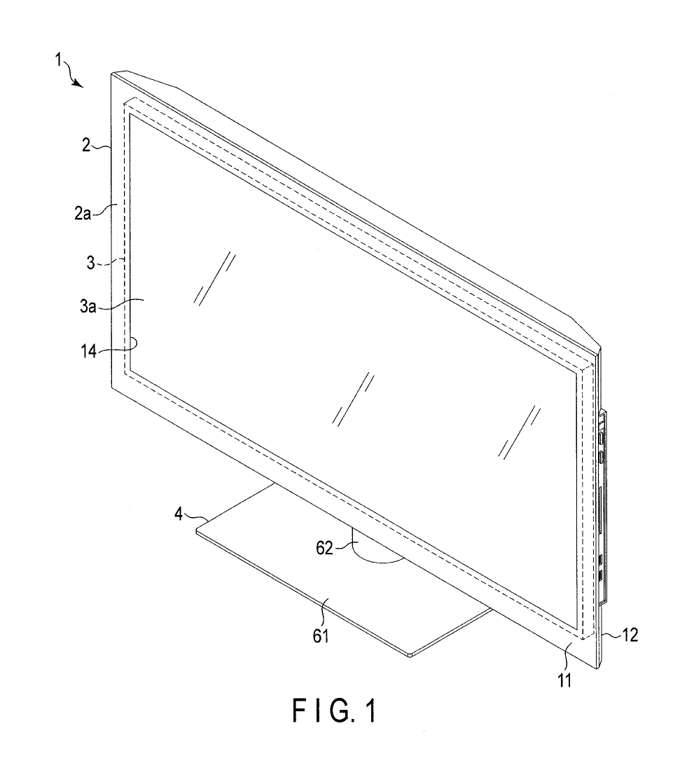

Hereinafter, a first embodiment is explained with reference to FIG. 1 to FIG. 5. In this specification, the near side (i.e., user side) is defined as forward, and the far side viewed from a user is defined as backward. Further, the left side viewed from the user is defined as leftward, and the right side viewed from the user is defined as rightward. The upper side viewed from the user is defined as upward, and the lower side viewed from the user is defined as downward. Moreover, some components are expressed by two or more terms. Those components may be further expressed by another or other terms. And the other components which are not expressed by two or more terms may be expressed by another or other terms. Each figure schematically shows an embodiment, and the dimension of each component disclosed in drawings may be different from explanations of the embodiments.

FIG. 1 is a perspective view showing a television receiving apparatus (hereinafter referred to as “television”) 1 according to the first embodiment. The television 1 is an example of the electronic apparatus. The electronic apparatus is not limited to the television 1, and may be a variety of electronic apparatuses which display images, such as, a tablet type of device, a portable computer, a liquid crystal display, a mobile game machine, a mobile phone and a smart phone.

As shown in FIG. 1, the television 1 comprises a housing 2, a display module 3 and a stand 4. The housing 2 could be also referred to as, for example, a wall, an outer shell or a cabinet. The display module 3 is, for example, a liquid crystal display (LCD), and could be also referred to as, for example, a panel, a unit, a displaying unit, an image forming unit or a member.

The housing 2 is formed by, for example, resin. The housing 2 comprises a front cover 11 and a rear cover 12. The rear cover 12 is attached to the front cover 11 by, for example, a screw and a claw.

The front cover 11 forms a front surface 2a of the housing 2. The front cover 11 comprises a display opening 14 opening on the front surface 2a. The display opening 14 is formed into a substantially rectangular shape, and is covered by, for example, a transparent glass panel. The display opening 14 may not be covered.

The display module 3 is accommodated in the housing 2. The display module 3 comprises a screen 3a which displays images. The screen 3a is exposed through the display opening 14.

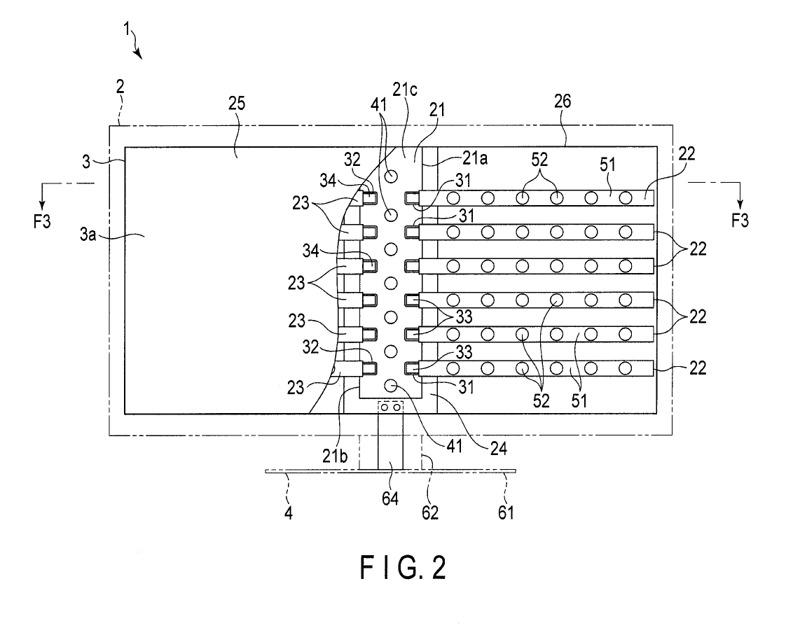

FIG. 2 is a front view of the television 1, showing the inner structure of the display module 3. In FIG. 2, the housing 2 and the stand 4 are partially shown by two-dot chain lines. As illustrated in FIG. 2, the display module 3 comprises a relay board 21, a plurality of first LED bars 22, a plurality of second LED bars 23, a heat releasing member 24, a liquid crystal panel 25 and a frame 26.

The relay board 21 is an example of the first board. The heat releasing member 24 is an example of the heat releasing portion, and could be also referred to as, for example, a metallic plate, a supporting member or an attaching member. The liquid crystal panel 25 is an example of the image display.

The liquid crystal panel 25 forms the screen 3a of the display module 3. The liquid crystal panel 25 displays images on the screen 3a in accordance with signals input from a controller of the television 1. The images can be easily viewed by users in terms of brightness by illuminating the liquid crystal panel 25 from behind.

The relay board 21 is, for example, a metallic printed wiring board formed into a substantially rectangular shape. The relay board 21 is formed by, for example, metal such as an aluminum alloy. The relay board 21 may be formed by, for example, bonding a metallic member to another member formed by a material such as resin and ceramics to each other. The relay board 21 may be formed by an insulator.

A radiation performance in a surface direction of the relay board 21 is, for example, 2W/m²K or more. The relay board 21 is in a central portion of the display module 3, and extends in an upper-and-lower (vertical) direction. The relay board 21 is behind (at the back of) the liquid crystal panel 25. In other words, the relay board 21 is closer to the rear cover 12 than the liquid crystal panel 25.

The relay board 21 comprises a first end 21a and a second end 21b. The second end 21b is located on a side opposite to the first end 21a. The first and second ends 21a and 21b are ends of the relay board 21 in a left-and-right (lateral) direction. The first and second ends 21a and 21b substantially perpendicularly extend. The first and second ends 21a and 21b are not limited to this structure, and may be formed into curved-line shapes, and may extend at a slant.

The relay board 21 comprises a plurality of first holes 31, a plurality of second holes 32, a plurality of first connectors 33 and a plurality of second connectors 34. The first and second holes 31 and 32 could be also referred to as openings, insertion portions or accommodating portions.

The plurality of first holes 31 are arranged in line along the first end 21a of the relay board 21. The plurality of second holes 32 are arranged in line along the second end 21b of the relay board 21.

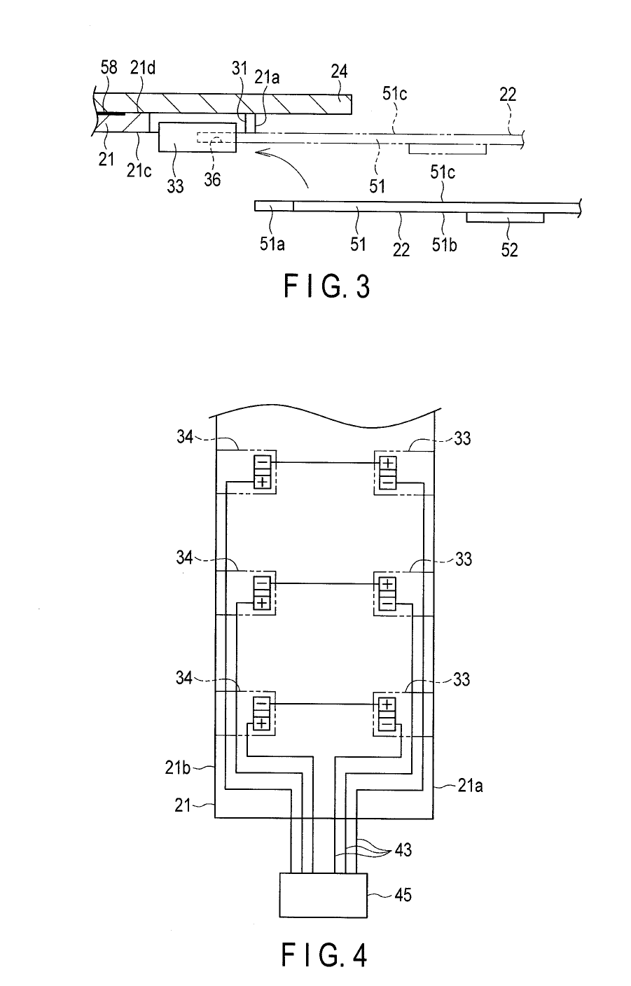

FIG. 3 is a cross-sectional view taken along the F3-F3 line of FIG. 2, showing the relay board 21, the first LED bar 22 and the heat releasing member 24. As illustrated in FIG. 3, the plurality of first connectors 33 are partially inserted into the corresponding first holes 31 respectively. The plurality of first connectors 33 protrude from a surface 21c of the relay board 21. The surface 21c is a surface of the relay board 21 facing the liquid crystal panel 25. Each of the first connectors 33 comprises a terminal such as a pin, and is mounted on the relay board 21.

Each of the first connectors 33 comprises an insertion opening 36. The insertion opening 36 of each first connector 33 opens toward the first end 21a of the relay board 21. The positions of the insertion openings 36 are aligned on the surface 21c of the relay board 21.

On the other hand, the plurality of second connectors 34 are partially inserted into the corresponding second holes 32 respectively. The plurality of second connectors 34 protrude from the surface 21c of the relay board 21. Each of the second connectors 34 comprises a terminal such as a pin, and is mounted on the relay board 21.

Similarly to the first connectors 33, each of the second connectors 34 comprises an insertion opening. The insertion openings of the second connectors 34 open toward the second end 21b of the relay board 21. The positions of the insertion openings of the second connectors 34 are aligned on the surface 21c of the relay board 21.

As illustrated in FIG. 2, a plurality of first LEDs 41 are on the surface 21c of the relay board 21. The first LEDs 41 are an example of the light emitting elements, and could be also referred to as, for example, light sources or backlights. Each of the first LEDs 41 comprises an LED element and a lens which covers the LED element. The first LEDs 41 are in a central portion of the relay board 21, and are set out at regular intervals in an upper-and-lower (vertical) direction.

FIG. 4 schematically shows a circuit formed on the relay board 21. In FIG. 4, the first and second connectors 33 and 34 are shown by two-dot chain lines, and the first and second holes 31 and 32 are omitted. As shown in FIG. 4, the relay board 21 comprises a plurality of relay lines 43. The relay lines 43 are connected to terminals of the first and second connectors 33 and 34 respectively in a corresponding manner.

The television 1 further comprises a driving circuit 45. The driving circuit 45 is a circuit that controls the first and second LED bars 22 and 23, and the first LEDs 41. The driving circuit 45 is, for example, on a printed wiring board which is different from the relay board 21. The driving circuit 45 is connected to the relay lines 43 via, for example, a flexible printed wiring board and a connector. The driving circuit 45 may be on the relay board 21.

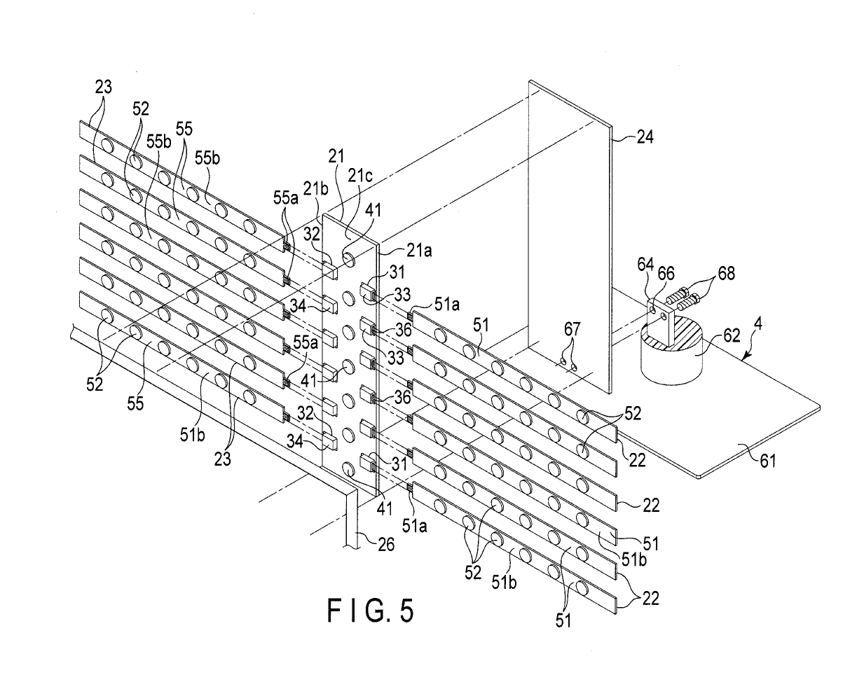

FIG. 5 is a perspective view showing the display module 3 and the stand 4 which are disassembled. As indicated in FIG. 5, each of the plurality of first LED bars 22 comprises a first base board 51 and a plurality of second LEDs 52. The first base board 51 is an example of the second board. The second LEDs 52 are an example of the light emitting elements, and could be also referred to as, for example, light sources or backlights.

The first base board 51 is a metallic system printed wiring board formed into a substantially rectangular shape. The first base board 51 is formed by metal such as an aluminum alloy. The first base board 51 may be formed by, for example, bonding a metallic member and another member formed by a material such as resin and ceramics to each other. The first base board 51 may be formed by an insulator. A radiation performance in a surface direction of the first base board 51 is, for example, 2W/m²K or more.

An end of the first base board 51 comprises an insertion portion 51a. By inserting the insertion portion 51a into the insertion opening 36 of the first connector 33, the first base board 51 is connected to the first connector 33. By this structure, the first base board 51 is attached to the relay board 21, and is electrically connected to the relay board 21 via the first connector 33.

The first base board 51 attached to the first connector 33 passes over the first end 21a of the relay board 21 and extends in a horizontal (lateral) direction. In other words, the first base board 51 is substantially orthogonal to the relay board 21. The first base board 51 may extend at a slant. The first base board 51 extends in a direction from the first connector 33 to the first end 21a of the relay board 21.

Each of the second LEDs 52 comprises an LED element, and a lens which covers the LED element. The plurality of second LEDs 52 are on a surface 51b of the first base board 51. The surface 51b is a surface of the first base board 51 facing the liquid crystal panel 25. The plurality of second LEDs 52 are arranged in line in a longitudinal direction of the first base board 51.

The second LEDs 52 are connected to the driving circuit 45 via the first base board 51, the first connector 33 and the relay board 21. The driving circuit 45 drives the second LEDs 52 via the first base board 51, the first connector 33 and the relay board 21. By this structure, the second LEDs 52 is configured to emit light.

As shown by two-dot chain lines in FIG. 3, when the first base board 51 is attached to the first connector 33, a rear surface 51c of the first base board 51 makes contact with the surface 21c of the relay board 21. In other words, the first base board 51 overlaps the relay board 21, and is thermally connected to the relay board 21. The first base board 51 may make contact with the relay board 21 via, for example, heat releasing grease. The rear surface 51c of the first base board 51 is located on a side opposite to the surface 51b.

On the other hand, as indicated in FIG. 5, each of the plurality of second LED bars 23 comprises the plurality of second LEDs 52 which are also provided in the first LED bars 22, and a second base board 55. The second base board 55 is an example of a third board.

The second base board 55 is the same as the first base board 51. Thus, the second base board 55 is a metallic system printed wiring board formed into a substantially rectangular shape. The second base board 55 may be a base board whose shape and material are different from the first base board 51.

An end of the second base board 55 comprises an insertion portion 55a. By inserting the insertion portion 55a into an insertion opening of the second connector 34, the second base board 55 is connected to the second connector 34. By this structure, the second base board 55 is attached to the relay board 21, and is electrically connected to the relay board 21 via the second connector 34.

The second base board 55 attached to the second connector 34 passes over the second end 21b of the relay board 21, and extends in a horizontal (lateral) direction. In other words, the second base board 55 is substantially orthogonal to the relay board 21. The second base board 55 may extend at slant. This means that the second base board 55 extends in a direction from the second connector 34 to the second end 21b of the relay board 21.

The second base boards 55 are in the same height as the corresponding first base boards 51 respectively. The plurality of first base boards 51 and the plurality of second base boards 55 are dyad-symmetrical (rotationally symmetrical). The first and second base boards 51 and 55 are not limited to this layout.

The plurality of second LEDs 52 are on a surface 55b of each second base board 55. The surface 55b is a surface of the second base board 55 facing the liquid crystal panel 25. The plurality of second LEDs 52 are arranged in line in a longitudinal direction of the second base boards 55.

The second LEDs 52 are connected to the driving circuit 45 via the second base board 55, the second connector 34 and the relay board 21. The driving circuit 45 drives the second LEDs 52 via the second base board 55, the second connector 34 and the relay board 21. By this structure, the second LEDs 52 emit light.

When the second base board 55 is attached to the second connector 34, the rear surface of the second base board 55 makes contact with the surface 21c of the relay board 21. In other words, the second base board 55 overlaps the relay board 21, and is thermally connected to the relay board 21. The second base board 55 and the relay board 21 may make contact with each other via, for example, heat releasing grease.

The heat releasing member 24 is formed into a substantially rectangular shape which is larger than the relay board 21. The heat releasing member 24 is formed by metal such as iron. The heat releasing member 24 may be formed by other materials.

The heat releasing member 24 is in the central portion of the display module 3, and extends in an upper-and-lower (perpendicular) direction. The heat releasing member 24 is behind (at the back of) the relay board 21. In other words, the heat releasing member 24 is closer to the rear cover 12 than the relay board 21. The heat releasing member 24 forms a part of the back surface of the display module 3.

The relay board 21 is attached to the heat releasing member 24 by, for example, a screw or an adhesive agent. The relay board 21 is thermally connected to the heat releasing member 24 by making contact with the heat releasing member 24. The relay board 21 and the heat releasing member 24 may come in contact with each other via, for example, heat releasing grease. The heat releasing member 24 strengthens the relay board 21.

As shown by a thick line in FIG. 3, a ground pattern 58 is provided on a rear surface 21d of the relay board 21. The rear surface 21d of the relay board 21 is located on a side opposite to the surface 21c. The ground pattern 58 is a pad (land) for securing ground for the relay board 21, and is electrically disconnected from the relay lines 43. The ground pattern 58 is electrically connected to the heat releasing member 24 by making contact with the heat releasing member 24.

As shown in FIG. 2, the frame 26 surrounds the relay board 21, the first and second LED bars 22 and 23, the heat releasing member 24 and the liquid crystal panel 25. The frame 26 is formed into a substantially rectangular shape by, for example, metal such as an aluminum alloy. The frame 26 may be formed by other materials.

Each of the relay board 21 and the heat releasing member 24 makes contact with the frame 26. Therefore, the relay board 21 and the heat releasing member 24 are thermally connected to the frame 26. The relay board 21 and the heat releasing member 24 may come in contact with the frame 26 via, for example, heat releasing grease. Further, the first and second base boards 51 and 55 may be thermally connected to the frame 26.

The stand 4 comprises a mounted portion 61 and a support 62. The mounted portion 61 is formed into, for example, a plate shape, and is mounted on a mounted surface such as a television stand. The support 62 protrudes from the mounted portion 61 and is attached to the housing 2. The support 62 rotatably supports the housing 2.

The support 62 comprises a supporting member 64. The supporting member 64 is formed by metal such as iron. The supporting member 64 is covered by a cover formed by, for example, resin.

As shown in FIG. 5, the supporting member 64 comprises a plurality of first attaching holes 66. The heat releasing member 24 comprises a plurality of second attaching holes 67. The second attaching holes 67 are at positions corresponding to the first attaching holes 66.

By a plurality of fixing members 68, the supporting member 64 of the support 62 is attached to the heat releasing member 24 of the display module 3. The fixing members 68 are, for example, screws for attaching the stand 4 to the housing 2.

The fixing members 68 are inserted into the first and second attaching holes 66 and 67 via holes of the rear cover 12. Via the fixing members 68, the heat releasing member 24 is thermally connected to the supporting member 64. Thus, the relay board 21 is thermally connected to the supporting member 64 of the stand 4 via the heat releasing member 24 and the fixing members 68. The relay board 21 may be thermally connected to the supporting member 64 of the stand 4 via the fixing members 68 by allocating, in the relay board 21, holes into which the fixing members 68 are inserted.

The aforementioned television 1 operates as follows. The controller of the television 1 inputs signals into the liquid crystal panel 25, and thus, the liquid crystal panel 25 displays images. At the same time, the controller of the television 1 makes the driving circuit 45 transmit driving signals to the first LEDs 41. Moreover, the driving circuit 45 transmits driving signals to the second LEDs 52 via the relay lines 43, and the first or second base board 51 or 55. In short, the relay board 21 relays signals to the second LEDs 52 from the driving circuit 45.

The first and second LEDs 41 and 52 are driven by the driving circuit 45 in such a way that the first and second LEDs 41 and 52 emit light. The liquid crystal panel 25 receives light from the first and second LEDs 41 and 52. Thus, bright images are displayed on the screen 3a of the display module 3. In short, the relay board 21, the first and second LED bars 22 and 23, and the driving circuit 45 are backlights of the display module 3.

The second LEDs 52 generate heat along with light emission. The heat generated from the second LEDs 52 is conducted to the first or second base board 51 or 55. The heat is conducted from a contact portion of the first or second base board 51 or 55 with the relay board 21 to the relay board 21. The heat is conducted from a contact portion of the relay board 21 with the heat releasing member 24 to the heat releasing member 24. Further, the heat is conducted to the supporting member 64 of the stand 4 via the fixing members 68. Thus, the second LEDs 52 are cooled by the relay board 21, the heat releasing member 24 and the supporting member 64.

On the other hand, heat generated from the first LEDs 41 is conducted to the relay board 21, the heat releasing member 24 and the supporting member 64. Thus, the first LEDs 41 are also cooled.

According to the television 1 of the first embodiment, the first base board 51 is thermally connected to the relay board 21. By conducting the heat generated from the second LEDs 52 from the first base board 51 to the relay board 21, the second LEDs 52 are cooled. This inhibits the decrease in reliability of the second LEDs 52 due to high temperature. Moreover, since cooling is ensured, it is possible to set the second LEDs 52 as high-output LEDs and reduce the number of second LEDs 52.

As described above, the relay board 21 cools the second LEDs 52. Therefore, an exclusive component for cooling the second LEDs 52 and the first base board 51 is unnecessary. Thus, the number of components of the television 1 can be reduced. In this manner, the second LEDs 52 can be cooled at low cost.

The first base board 51 directly makes contact with the relay board 21. Therefore, heat is more efficiently conducted from the first base board 51 to the relay board 21 than a case where another member is interposed. Thus, the second LEDs 52 can be efficiently cooled. Moreover, since no other member is interposed, the television 1 can be thinner and lighter.

The relay board 21 is connected to each of the first and second base boards 51 and 55 extending in directions substantially opposite to each other. The relay board 21 is used for cooling the second LEDs 52, and can also relay the first and second base boards 51 and 55. For example, even if the maximum length of the first and second base boards 51 and 55 is limited due to manufacturing restrictions, the existence of the relay board 21 enables the size of the screen 3a of the display module 3 to be enlarged. Thus, the second LEDs 52 can be cooled at low cost through the cooling and relaying processes conducted by the relay board 21.

The relay board 21 is a metallic printed wiring board. Therefore, the heat of the first base board 51 is efficiently conducted to the relay board 21. Thus, the second LEDs 52 can be efficiently cooled. Similarly, in the case where the relay board 21 is formed by a metallic member and another member which are bonded each other, the second LEDs 52 can be efficiently cooled.

The first base board 51 is a metallic printed wiring board. Therefore, the heat of the second LEDs 52 is efficiently conducted to the first base board 51. Thus, the second LEDs 52 can be efficiently cooled. Similarly, in the case where the first base board 51 is formed by a metallic member and another member which are bonded each other, the second LEDs 52 can be efficiently cooled.

The first base board 51 is the same as the second base board 55. In other words, the first and second base boards 51 and 55 are common to each other. This enables the production costs of the first and second base boards 51 and 55 to be decreased. Further, the first and second base boards 51 and 55 can be easily managed, and the television 1 can be easily constructed.

The relay board 21 is thermally connected to the heat releasing member 24. This enables the heat conducted from the first base board 51 to the relay board 21 to be released to the heat releasing member 24. Therefore, the second LEDs 52 can be efficiently cooled.

The heat releasing member 24 may only be thermally connected to the relay board 21, and may not form the whole area of the rear surface of the display module 3. Therefore, the releasing member 24 made from metal which is more expensive than, for example, resin, can be downsized. Thus, the increase in the production costs of the television 1 can be constrained.

The ground pattern 58 of the relay board 21 is electrically connected to the metallic heat releasing member 24. By this structure, it is possible to ensure the ground for the relay board 21 and the first and second LED bars 22 and 23. Moreover, by the contact of the ground pattern 58 which is a metallic film with the heat releasing member 24, the heat of the relay board 21 can be efficiently conducted to the heat releasing member 24.

The relay board 21 is thermally connected to the frame 26. This enables the heat conducted from the first base board 51 to the relay board 21 to be released to the frame 26. Therefore, the second LEDs 52 can be efficiently cooled.

The relay board 21 is thermally connected to the supporting member 64 of the stand 4 via the heat releasing member 24 and the fixing members 68. By this structure, the heat conducted from the first base board 51 to the relay board 21 can be released to the supporting member 64. Therefore, the second LEDs 52 can be efficiently cooled.

The first LEDs 41 are on the relay board 21. The first LEDs 41 are between the first LED bars 22 and the second LED bars 23. Thus, it is possible to equalize the brightness of the screen 3a of the display module 3.

The first base boards 51 and the second base boards 55 are rotationally symmetrical. This enables the brightness of the screen 3a of the display module 3 to be equalized. Further, the television 1 can be easily constructed.

In the above explanations, the cooling of the second LEDs 52 on the first base boards 51 is mainly described. The similar processes are applied to the cooling of the second LEDs 52 on the second base boards 55.

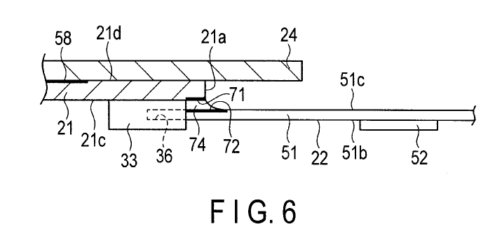

Next, a second embodiment is explained by reference to FIG. 6. In the embodiment disclosed below, structural components having the same functions as the television 1 of the first embodiment are denoted by the same reference numerals. The explanations of these structural components may be partially or fully omitted.

FIG. 6 is a cross-sectional view showing a relay board 21, a first LED bar 22 and a heat releasing member 24 according to the second embodiment. As indicated in FIG. 6, the relay board 21 does not comprise a first or second hole 31 or 32. Instead of the holes, the relay board 21 comprises a plurality of first dummy patterns 71. First and second connectors 33 and 34 are on a surface 21c of the relay board 21.

Each of the first dummy patterns 71 is between the corresponding first or second connector 33 or 34 and a first or second end 21a or 21b of the relay board 21. The first dummy patterns 71 are formed on the surface 21c of the relay board 21. The first dummy patterns 71 are electrically disconnected from relay lines 43.

A first base board 51 comprises a second dummy pattern 72. The second dummy pattern 72 is adjacent to an insertion portion 51a, and is formed on a rear surface 51c of the first base board 51. When the first base board 51 is connected to the first connector 33, the second dummy pattern 72 faces the first dummy pattern 71.

There is a space between the relay board 21 and the first base board 51 connected to the first connector 33. In this space, solder 74 intervenes. The solder 74 adheres to the first dummy pattern 71 and the second dummy pattern 72. Thus, the first base board 51 is thermally connected to the relay board 21 via the solder 74. The solder 74 is formed by, for example, applying a reflow treatment to a solder paste applied to the first or second dummy pattern 71 or 72.

A second base board 55 comprises the second dummy pattern 72 similarly to the first base board 51. The solder 74 is also interposed between the second dummy pattern 72 of the second base board 55 and the first dummy pattern 71.

According to a television 1 of the second embodiment, the relay board 21 is thermally connected to the first and second base boards 51 and 55 by the solder 74. By this structure, even if a space is formed between the relay board 21 and the first or second base board 51 or 55, the second LEDs 52 can be cooled. Further, the first and second base boards 51 and 55 can be attached to the relay board 21 by the solder 74.

The member which thermally connects the relay board 21 to the first or second base board 51 or 55 is not limited to the solder 74. For example, another member such as a heat transmitting sheet may be interposed between the relay board 21 and the first or second base board 51 or 55.

According to at least one of the electronic apparatuses described above, the second board comprising the light emitting elements is thermally connected to the first board. In this structure, the heat generated from the light emitting elements is conducted to the first board via the second board. Therefore, it is possible to cool the light emitting elements at low cost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the above embodiments, the first and second base boards 51 and 55 partially make contact with the relay board 21. The first and second base boards 51 and 55 are not limited to this structure. The entire area of the rear surfaces of the first and second base boards 51 and 55 may come in contact with the relay board 21.

What is claimed is:

1. An electronic apparatus comprising:
a first board;
a second board attached to the first board and thermally connected to the first board;
light emitting elements provided on the second board and configured to emit light; and
an image display configured to be illuminated by the light emitting elements and to display an image.

2. The electronic apparatus of claim 1, further comprising:
a third board attached to the first board and thermally connected to the first board; and
light emitting elements provided on the third board and configured to emit light,
wherein the first board comprises a first connector to which the second board is connected, a second connector to which the third board is connected, a first end, and a second end on a side opposite to the first end,
the second board extends in a direction from the first connector to the first end, and
the third board extends in a direction from the second connector to the second end.

3. The electronic apparatus of claim 2, wherein the second board is the same as the third board.

4. The electronic apparatus of claim 1, wherein the first board is formed by metal, or by a metallic member and another member which are bonded each other.

5. The electronic apparatus of claim 1, wherein the second board is formed by metal, or by a metallic member and another member which are bonded each other.

6. The electronic apparatus of claim 1, further comprising a heat releasing portion attached to the first board and thermally connected to the first board.

7. The electronic apparatus of claim 6, wherein
the heat releasing portion is formed by metal, and
the first board comprises a ground pattern electrically connected to the heat releasing portion.

8. The electronic apparatus of claim 1, further comprising a driving circuit configured to drive the light emitting elements via the first board.

9. The electronic apparatus of claim 1, further comprising a frame surrounding the first board, the second board, the light emitting elements and the image display, and thermally connected to the first board.

10. The electronic apparatus of claim 1, further comprising:
a housing accommodating the first board, the second board, the light emitting elements and the image display; and
a stand supporting the housing and thermally connected to the first board.

11. The electronic apparatus of claim 1, further comprising light emitting elements provided on the first board and configured to emit light.
